(19) United States
(12) Patent Application Publication
(10) Pub. No.: US 2014/0095778 A1
(43) Pub. Date: Apr. 3, 2014

(54) METHODS, SYSTEMS AND APPARATUS TO CACHE CODE IN NON-VOLATILE MEMORY

(71) Applicants: Jaewoong Chung, Sunnyvale, CA (US); Youfeng Wu, Santa Clara, CA (US); Cheng Wang, San Ramon, CA (US)

(72) Inventors: Jaewoong Chung, Sunnyvale, CA (US); Youfeng Wu, Santa Clara, CA (US); Cheng Wang, San Ramon, CA (US)

(21) Appl. No.: 13/630,651

(22) Filed: Sep. 28, 2012

(51) Int. Cl. G06F 12/00

(52) U.S. Cl. 711/104; 711/E12.001

(57) ABSTRACT

Methods and apparatus are disclosed to cache code in non-volatile memory. A disclosed example method includes identifying an instance of a code request for first code, identifying whether the first code is stored on non-volatile (NV) random access memory (RAM) cache, and when the first code is absent from the NV RAM cache, adding the first code to the NV RAM cache when a first condition associated with the first code is met and preventing storage of the first code to the NV RAM cache when the first condition is not met.

### FIELD OF THE DISCLOSURE

This disclosure relates generally to compilers, and, more particularly, to methods, systems and apparatus to cache code in non-volatile memory.

### BACKGROUND

Dynamic compilers attempt to optimize code during runtime as one or more platform programs are executing. Compilers attempt to optimize the code to improve processor performance. However, the compiler code optimization tasks also consume processor resources, which may negate one or more benefits of resulting optimized code if such optimization efforts consume a greater amount of processor resources than can be saved by the optimized code itself.

### BRIEF DESCRIPTION OF THE DRAWINGS

FIG. 1 is a schematic illustration of an example portion of a processor platform consistent with the teachings of this disclosure to cache code in non-volatile memory.

FIG. 2 is an example code condition score chart generated by a cache manager in the platform of FIG. 1.

FIG. 3 is an example code performance chart generated by the cache manager in the platform of FIG. 1.

FIG. 4 is a schematic illustration of an example cache manager of FIG. 1.

FIGS. 5A, 5B and 6 are flowcharts representative of example machine readable instructions which may be executed to cache code in non-volatile memory.

FIG. 7 is a schematic illustration of an example processor platform that may execute the instructions of FIGS. 5A, 5B and 6 to implement the example systems and apparatus of FIGS. 1-4.

### DETAILED DESCRIPTION

Code optimization techniques may employ dynamic compilers at runtime to optimize and/or otherwise improve execution performance of programs. Interpreted code, for example, may be compiled to machine code during execution via a just-in-time (JIT) compiler and cached so that subsequent requests by a processor for one or more functions (e.g., processes, subroutines, etc.) occur relatively faster because the compiled code is accessed from a cache memory. In other examples, dynamic binary translators translate a source instruction to a target instruction in a manner that allows a target machine (e.g., a processor) to execute the instructions. The first time a processor requests code (e.g., a function call), extra time (e.g., processor clock cycles) is consumed to translate the source code into a format that the processor can handle. However, the translated code may be stored in the cache memory to allow the processor to retrieve the target code at a subsequent time, in which access to the cache memory may be faster than re-compiling the source code.

In some systems, code is compiled and cached upon startup. However, such compilation at startup consumes a significant amount of processor overhead to generate compiled code for later use. The overhead is sometimes referred to as “warm-up time,” or “lag time.” Such efforts sacrifice processor performance early in program execution in an effort to yield better results in the long run in the event the program operates for a relatively long period of time and/or repeatedly calls the same functions relatively frequently. Optimized compiled code may be stored on hard disks (e.g., magnetic hard drive, solid state disk, etc.) to avoid a future need for re-compilation of the original code. However, hard disk access times may be slower than an amount of time required for a dynamic compiler to re-compile the original code, thereby resulting in initially slow startup times (i.e., relatively high lag time) when a program is started (e.g., after powering-up a platform). In other words, the amount of time to retrieve the optimized compiled code from storage may take more time than the amount of time to re-compile and/or re-optimize the original code when a processor makes a request for the code.

While enabling processor cache and/or accessing DRAM reduces an amount of time to retrieve previously optimized compiled code when compared to hard disk access latency, the processor cache is volatile memory that loses its memory contents when power is removed, such as during instances of platform shutdown. Processor cache may include any number of cache layers, such as level-1 (L1), level-2 (L2) (e.g., multi-level cache). Multi-level cache reduces processor fetch latency by allowing the processor to check for desired code in the cache prior to attempting a relatively more time consuming fetch for code from hard disk storage. Cache is typically structured in a hierarchical fashion with low latency, high cost, smaller storage at level 1 (e.g., L1), and implements slower, larger, and less expensive storage at each subsequent level (e.g., L2, L3, etc.).

L1 and L2 cache, and/or any other cache level, is typically smaller than random access memory (RAM) associated with a processor and/or processor platform, but is typically faster and physically closer to the processor to reduce fetch latency. The cache is also relatively smaller than RAM because, in part, it may consume a portion of the processor footprint (e.g., on-die cache). Additionally, a first level cache (L1) is typically manufactured with speed performance characteristics that exceed subsequent layer cache levels and/or RAM, thereby demanding a relatively higher price point. Subsequent cache layers typically include a relatively larger amount of storage capacity, but are physically further away and/or include performance characteristics lower than that of first layer cache. In the event the processor does not locate desired code (e.g., one or more instructions, optimized code, etc.) in the first layer of cache (e.g., L1 cache), a second or subsequent layer of cache (e.g., L2 cache, DRAM) may be checked prior to a processor fetch to external storage (e.g., a hard disk, flash memory, solid state disk, etc.). Thus, most caches are structured to redundantly store data written in a first layer of cache (e.g., L1), at all lower levels of cache (e.g., L2, L3, etc.) to reduce access to main memory.

While storing compiled code in the cache facilitates latency reduction by reducing a need for re-optimization, re-compilation and/or main memory access attempts, the cache is volatile. When the platform shuts-down and/or otherwise loses power, all contents of the cache are lost. In some examples, cache memory (e.g., L1 cache, L2 cache, etc.) includes dynamic RAM (DRAM), which enables byte level accessibility that also loses its data when power is removed. Byte level accessibility enables processors and/or binary translators to quickly operate on relatively small amounts of information rather than large blocks of memory. In some examples, the processor only needs to operate on byte-level portions of code rather than larger blocks of code. In the event large blocks of code are fetched, additional fetch (transfer) time is wasted to retrieve portions of code not needed by the processor. While FLASH memory retains memory after power is removed, it cannot facilitate byte level read and/or write operations and, instead, accesses memory in blocks. Accordingly, FLASH memory may not serve as the most suitable cache memory type due to the relatively high latency access times at the block level rather than at a byte level.

Non-volatile (NV) RAM, on the other hand, may exhibit data transfer latency characteristics comparable to L1, L2 cache and/or dynamic RAM (DRAM). Further, when the platform loses power (e.g., during shutdown, reboot, sleep mode, etc.), NV RAM maintains its memory contents for use after platform power is restored. Further still, NV RAM facilitates byte-level accessibility. However, NV RAM has a relatively short life cycle when compared to traditional L1 cache memories, L2 cache memories and/or DRAM. A life cycle for a memory cell associated with NV RAM refers to a number of memory write operations that the cell can perform before it stops working. Example methods, apparatus, systems and/or articles of manufacture disclosed herein employ a non-volatile RAM-based persistent code cache that maintains memory contents during periods of power loss, exhibits latency characteristics similar to traditional L1/L2 cache, and manages write operations in a manner that extends memory life in view of life cycle constraints associated with NV RAM cache.

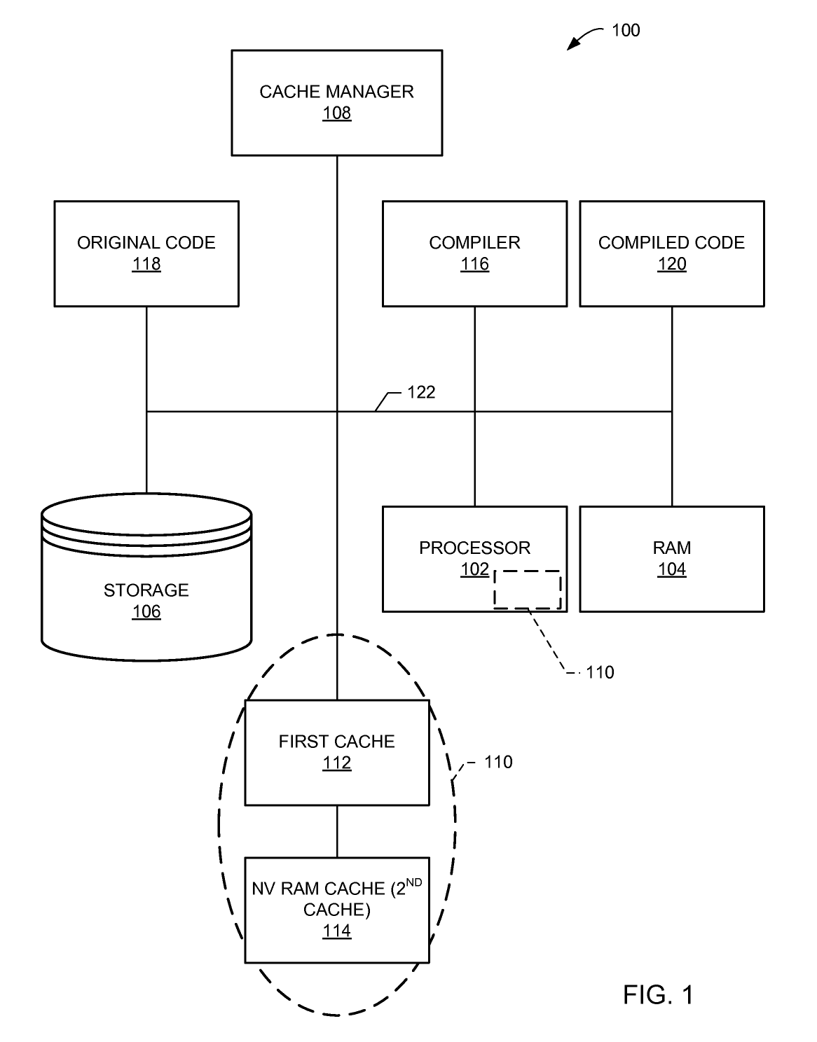

FIG. 1 illustrates portion of an example processor platform 100 that includes a processor 102, RAM 104, storage 106 (e.g., hard disk), a cache manager 108 and a cache memory system 110. While the example cache memory system 110 is shown in the illustrated example of FIG. 1 as communicatively connected to the example processor 102 via a bus 122, the example cache memory system 110 may be part of the processor 102, such as integrated with a processor die. The example cache memory system 110 may include any number of cache devices, such as a first level cache 112 (e.g., L1 cache) and a second level cache 114 (e.g., L2 cache). In the illustrated example, L1 and L2 cache are included, and the L2 cache is an NV RAM cache. The example platform 100 of FIG. 1 also includes a compiler 116, which may obtain original code portions 118 from the storage 106 to generate optimized compiled code 120. The example compiler 116 of FIG. 1 may be a dynamic compiler (e.g., a just-in-time (JIT) compiler) or a binary translator.

In operation, the example processor 102 requests one or more portions of code by first accessing the cache memory system 110 in an effort to reduce latency. In the event requested code is found in the first level cache 112, the code is retrieved by the processor 102 from the first level cache 112 for further processing. In the event requested code is not found in the example first level cache 112, the processor 102 searches one or more additional levels of the hierarchical cache, if any, such as the example second level cache 114. If found within the example second level cache 114, the processor retrieves the code from the second level cache for further processing. In the event the requested code is not found in any level of the cache (e.g., cache levels 112, 114) of the example cache memory system 110 (e.g., a “cache miss” occurs), then the processor initiates fetch operation(s) to the example storage 106. Fetch operations to the storage (e.g., main memory) 116 are associated with latency times that are relatively longer than the latency times associated with the levels of the example cache memory system 110. Additional latency may occur by compiling, optimizing and/or otherwise translating the code via the example compiler 116 retrieved from storage 106, unless already stored in DRAM or cache memory.

In response to a cache miss, the example cache manager 108 analyses the processor code request(s) to determine whether the requested code should be placed in the example second level cache 114 after it has been compiled, optimized and/or otherwise translated by the example compiler 116. In some examples, a least-recently used (LRU) eviction policy level may be employed with the example first level cache 112, in which the code stored therein that is oldest and/or otherwise least accessed is identified as a candidate for deletion to allocate space for alternate code requested by the example processor 102. While the code evicted from the first level cache 112 could be transferred and/or otherwise stored to the example second level cache 114 in a manner consistent with a cache management policy (e.g., an LRU policy), the example cache manager 108 of FIG. 1 instead evaluates one or more conditions associated with the code to determine whether it should be stored in the example second level cache 114, or whether any current cache policy storage actions should be blocked and/or otherwise overriden. In some examples, the cache manager 108 prevents storage of code to the second level NV RAM cache 114 in view of the relatively limited write-cycles associated with NV RAM, which is not a limitation for traditional volatile RAM device(s) (e.g., DRAM).

Conditions that may influence decisions by the example cache manager 108 to store or prevent storage in the example second level NV RAM cache 114 include, but are not limited to, (1) a frequency with which the code is invoked by the example processor 102 per unit of time (access frequency), (2) an amount of time consumed by platform resources (e.g., processor cycles) to translate, compile, and/or otherwise optimize the candidate code, (3) a size of the candidate code, (4) an amount of time with which the candidate code can be accessed by the processor (cache access latency), and/or (5) whether or not the code is associated with power-up activities (e.g., boot-related code). In some examples, the cache manager 108 of FIG. 1 compares one or more condition values against one or more thresholds to determine whether to store candidate code to the second level cache 114. For example, in response to a first condition associated with a number of times the processor 102 invokes a code sample per unit of time, the example cache manager may allow the code sample to be stored in a first level cache, but prevent the code sample from being stored in a second level cache. On the other hand, if an example second condition associated with the number of times the processor 102 invokes the code sample is greater than the example first condition (e.g., exceeds a count threshold), then the example cache manager 108 may permit the code sample to be stored in the NV RAM cache 114 for future retrieval with reduced latency.

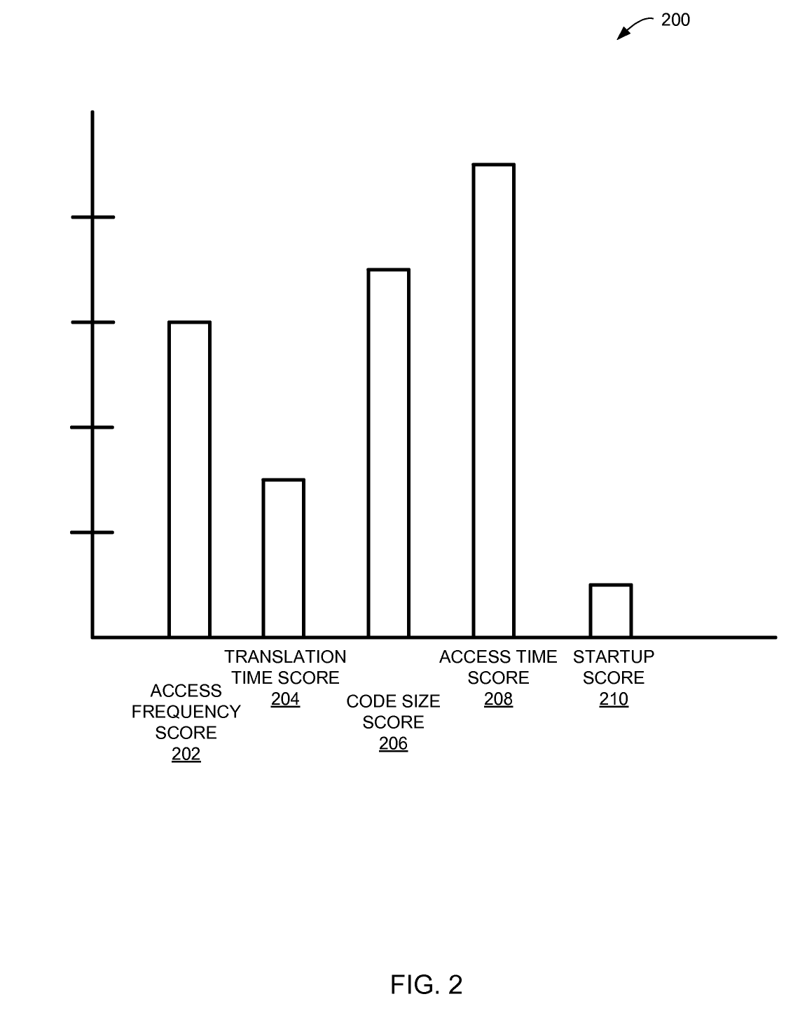

The example of FIG. 2 illustrates a code condition score chart 200 generated by the cache manager 108 for five (5) example conditions associated with an example block of code. A first example condition includes an access frequency score 202, a second example condition includes a translation time score 204, a third example condition includes a code size score 206, a fourth example condition includes an access time score 208, and a fifth example condition includes a startup score 210. Each score in the illustrated example of FIG. 2 is developed by tracking the corresponding code that has been requested by the example processor 102 and/or compiled by the example compiler 116. In some examples, scores for each of the conditions are determined and/or updated by the example compiler 116 during one or more profiling iterations associated with the example platform 100 and/or one or more programs executing on the example platform 100. Although FIG. 2 shows five (5) conditions for one example code sample, other charts for other code samples are likewise maintained. In some examples, threshold values for each condition type are based on an average value for the corresponding code sample, such as across a selection of code samples.

The example access frequency score 202 of FIG. 2 indicates a frequency with which the candidate code sample is invoked by the processor (e.g., number of invocations or calls per unit of time). In the event the candidate code sample is invoked relatively frequently in comparison to other code sample associated with the platform and/or executing program, then the example access frequency score 202 will exhibit a relatively higher value. The example cache manager 108 may establish a threshold in view of the relative performance of the candidate code sample. On the other hand, if the candidate code sample is invoked relatively infrequently (e.g., in comparison to other code sample invoked by the processor 102), then the example access frequency score 202 will exhibit a lower value. Generally speaking, a higher score value in the example chart 200 reflects a greater reason to store the candidate code sample in the example second level NV RAM cache 114. On the other hand, in the event the code sample is called relatively infrequently, then the example cache manager 108 may prevent the candidate code sample from being written to the NV RAM cache 114 in an effort to reduce a number of write operations, thereby extending the usable life of the NV RAM cache 114.

The example translation time score 204 of FIG. 2 reflects an indication of how long a resource (e.g., a compiler, a translator, etc.) takes to compile and/or otherwise translate the corresponding code sample. In the event the candidate code sample takes a relatively long amount of time to compile, optimize, and/or translate, then a corresponding translation time score 204 will be higher. Generally speaking, a higher value for the example translation time score 204 indicates that the candidate code sample should be stored in the example NV RAM cache 114 to reduce one or more latency effects associated with re-compiling, re-optimizing and/or re-translating the code sample during subsequent calls by the example processor 102. On the other hand, in the event the candidate code sample is compiled, optimized and/or translated relatively quickly when compared to other code samples, then the example cache manager 108 may assign a relatively low translation time score 204 to the candidate code sample. If the translation time score 204 is below a corresponding threshold value, then the cache manager 108 will prevent the candidate code sample from being stored in the example NV RAM cache 114 because re-compilation efforts will not likely introduce undesired latency. One or more thresholds may be based on, for example, statistical analysis. In some examples, statistical analysis may occur across multiple code samples and multiple charts, such as the example chart 200 of FIG. 2.

The example code size score 206 of FIG. 2 reflects an indication of a relative amount of storage space consumed by the candidate code sample when compared to other code samples compiled by the example compiler 116 and/or processed by the example processor 102. The example cache manager 108 assigns relatively small sized code sample with higher score values in an effort to conserve storage space of the example NV RAM cache 114. The example access time score 208 reflects an indication of how quickly stored cache can be accessed. Code samples that can be accessed relatively quickly are assigned by the example cache manager 108 to have a relatively higher score when compared to code samples that takes longer to access. In some examples, an amount of time to access the code sample is proportional to the corresponding size of the candidate code sample.

The example startup score 210 reflects an indication of whether the candidate code sample is associated with startup activities, such as boot process program(s). In some examples, a startup score 210 may be a binary value (yes/no) in which greater weight is applied to circumstances in which the code sample participates in startup activities. Accordingly, a platform that boots from a previously powered-off condition may experience improved startup times when corresponding startup code is accessed from the example NV RAM cache 114 rather than retrieved from storage 106, processed and/or otherwise compiled by the example compiler 116.

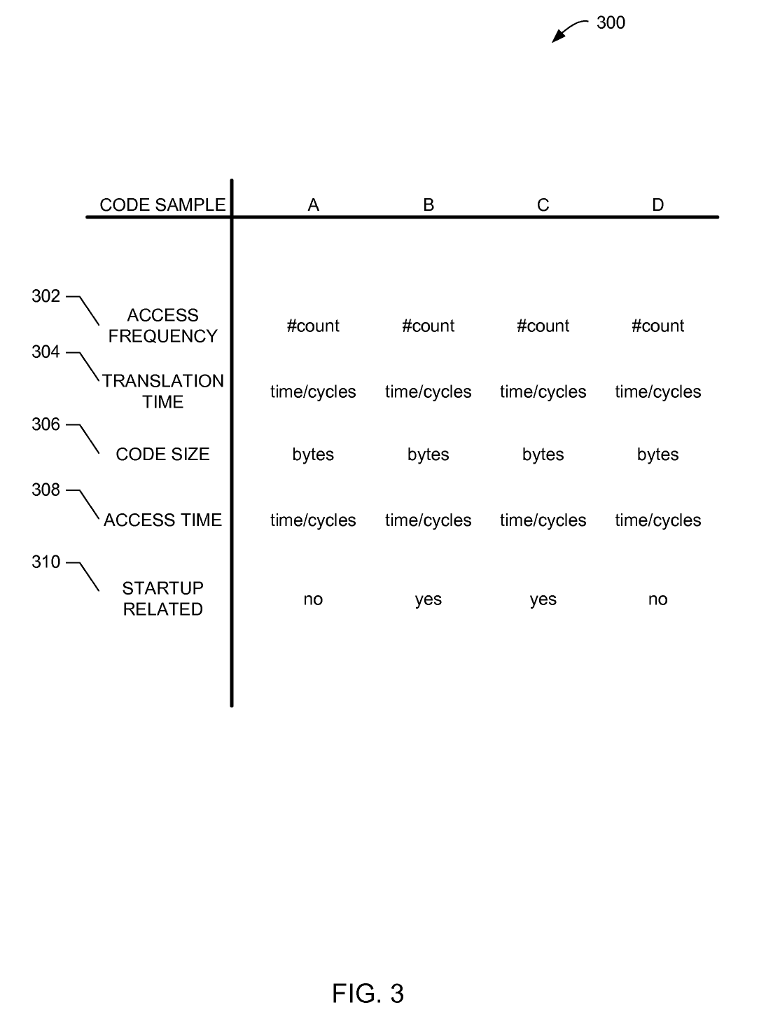

The example of FIG. 3, illustrates an example code performance chart 300 generated by the cache manager 108 to identify relative differences between candidate code samples. The example code performance chart 300 of FIG. 3 includes candidate code samples A, B, C and D, each of which include a corresponding condition value. The example condition values (metrics) of FIG. 3 include, but are not limited to, an access frequency condition 302, a translation time condition 304, a code size condition 306, an access time condition 308, and a startup condition 310. Each of the conditions may be populated with corresponding values for a corresponding code sample by one or more profile operation(s) of the example compiler 116 and/or cache manager 108.

In the illustrated example of FIG. 3, values associated with the access frequency condition 302 represent counts of instances where the corresponding candidate code sample has been invoked by the processor 102, and values associated with the translation time 304 represent a time or number of processor cycles consumed by the processor 102 to translate, compile and/or otherwise optimize the corresponding candidate code sample. Additionally, values associated with the code size condition 306 represent a byte value for the corresponding candidate code sample, values associated with the access time 308 represent a time or number of processor cycles consumed by the processor 102 to access the corresponding candidate code sample, and values associated the startup condition 310 represent a binary indication of whether the corresponding candidate code sample participates in one or more startup activities of a platform.

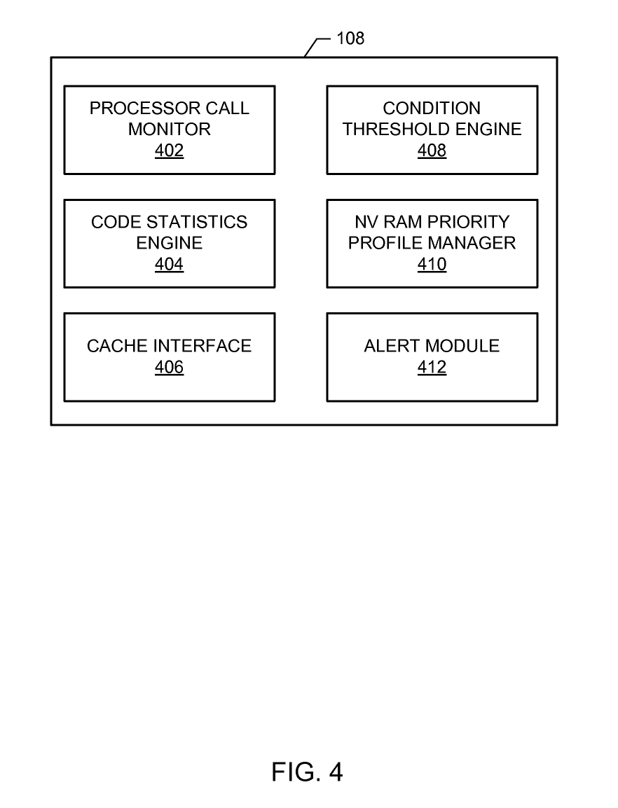

FIG. 4 is a schematic illustration of an example implementation of the example cache manager 108 of FIG. 1. In the illustrated example of FIG. 4, the cache manager 108 includes a processor call monitor 402, a code statistics engine 404, a cache interface 406, a condition threshold engine 408, an NV RAM priority profile 410 and an alert module 412. In operation, the example processor call monitor 402 determines whether the example processor 102 attempts to invoke a code sample. In response to detecting that the example processor 102 is making a call for a code sample, the example code statistics engine 404 logs which code sample was called and saves such updates statistic values to storage, such as the example storage 106 of FIG. 1 and/or to DRAM. In the illustrated example, statistics cultivated and/or otherwise tracked by the example code statistics engine 404 include a count of the number of times a particular code sample (e.g., a function, a subroutine, etc.) is called by the example processor 102 (e.g., call count, call per unit of time, etc.), a number of cycles consumed by platform resources to compile a particular code sample, a size of a particular code sample, an access time to retrieve a particular code sample from NV RAM cache 114, and/or whether the particular code sample is associated with startup activities.

The example cache interface 406 determines whether the code sample requested by the processor 102 is located in the first level cache 112 and, if so, forwards the requested code sample to the processor 102. On the other hand, if the code sample requested by the processor 102 is not located in the first level cache 112, the example cache interface 406 determines whether the requested code sample is located in the NV RAM cache 114. If the code sample requested by the processor 102 is located in the NV RAM cache 114 (second level cache), then the example cache interface 406 forwards the requested code sample to the processor 102. On the other hand, if the requested code sample is not in the NV RAM cache 114, then the example cache manager 108 proceeds to evaluate whether the requested code sample should be placed in the NV RAM cache 114 for future access.

To evaluate whether the requested code sample should be placed in the NV RAM cache 114 for future access, the example code statistics engine 404 accesses statistics related to the requested code sample that have been previously stored in storage 106. In some examples, the code statistics engine 404 maintains statistics associated with each of code sample received since the last time the platform was powered up from a cold boot, while erasing and/or otherwise disregarding any statistics of the portions of code that have been collected prior to the platform power application. In other examples, the code statistics engine 404 maintains statistics associated with each of code sample since the platform began operating to characterize each code sample over time. As described above, each code characteristic may have an associated threshold (an individual threshold) based on the relative performance of code portions processed by the example processor 102 and/or compiled by the example compiler 116. In the event the individual threshold value for a particular condition is exceeded for a given candidate code sample, then the example cache interface 406 adds the given candidate code sample to the NV RAM cache 114.

In some examples, none of the individual characteristic thresholds are exceeded for a given candidate code sample, but an aggregate of the values for the various condition types (e.g., a write frequency count, a translation time, a code size, an access time, etc.) may aggregate to a value above an aggregate score. If so, then the example cache interface 406 of FIG. 4 adds the candidate code to the NV RAM cache 114. In the event that none of the individual threshold values for each condition type are exceeded, and an aggregate value for two or more example condition types do not meet or exceed an aggregate threshold value, the example NV RAM priority profile manager 410 of the illustrated example determines whether the candidate code sample is associated with startup tasks. If so, then the priority profile manager 410 may invoke the cache interface 406 to add the candidate code sample to the NV RAM cache 114 so that the platform will startup faster upon a power cycle. The example NV RAM priority profile manager 410 may be configured and/or otherwise tailored to establish and/or adjust individual threshold values for each condition type, establish and/or adjust aggregate threshold values for two or more condition types, and/or determine whether all or some candidate code is to be stored in the example NV RAM cache 114 if it is associated with one or more startup task(s).

In some examples, the cache manager 108 monitors the NV RAM cache 114 for its useful life. For example, some NV RAM types have a lifetime write count of 10,000, while other NV RAM types have a lifetime write count of 100,000. While current and/or future NV RAM types may have any other write count limit value(s), the example cache manager 108 may monitor such write cycles to determine whether a useful life limit is approaching. One or more threshold values may be adjusted based on, for example, particular useful life limit expectations for one or more types of NV RAM. In some examples, NV RAM may be user-serviceable and, in the event of malfunction, end of life cycle, and/or upgrade activity, the NV RAM may be replaced. In some examples, the profile manager 410 compares an expected lifetime write value for the NV RAM cache 114 against a current write count value. Expected lifetime write values may differ between one or more manufacturers and/or models of NV RAM cache. In the event a current count is near and/or exceeds a lifetime count value, one or more alerts may be generated. In other examples, the NV RAM priority profile manager 410 of FIG. 4 determines if a rate of write cycles increases above a threshold value. In either case, the example alert module 412 may be invoked to generate one or more platform alerts so that user service may occur before potential failures affect platform operation(s).

While an example manner of implementing the example platform 100 and/or the example cache manager 108 to cache code in non-volatile memory has been illustrated in FIGS. 1-4, one or more of the elements, processes and/or devices illustrated in FIGS. 1-4 may be combined, divided, re-arranged, omitted, eliminated and/or implemented in any other way. Further, any or all of the example cache manager 108, the example first cache 112, the example NV RAM cache 114, the example processor call monitor 402, the example code statistics engine 404, the example cache interface 406, the example condition threshold engine 408, the example NV RAM priority profile manager 410 and/or the example alert module 412 of FIGS. 1-4 may be implemented by hardware, software, firmware and/or any combination of hardware, software and/or firmware. Additionally, and as described below, the example cache manager 108, the example first cache 112, the example NV RAM cache 114, the example processor call monitor 402, the example code statistics engine 404, the example cache interface 406, the example condition threshold engine 408, the example NV RAM priority profile manager 410 and/or the example alert module 412 of FIGS. 1-4 may be implemented by hardware, software, firmware and/or any combination of hardware, software and/or firmware. Thus, for example, any of the example cache manager 108, the example first cache 112, the example NV RAM cache 114, the example processor call monitor 402, the example code statistics engine 404, the example cache interface 406, the example condition threshold engine 408, the example NV RAM priority profile manager 410 and/or the example alert module 412 of FIGS. 1-4 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example cache manager 108, the example first cache 112, the example NV RAM cache 114, the example processor call monitor 402, the example code statistics engine 404, the example cache interface 406, the example condition threshold engine 408, the example NV RAM priority profile manager 410 and/or the example alert module 412 of FIGS. 1-4 are hereby expressly defined to include a tangible computer readable storage medium such as a memory, DVD, CD, Blu-ray, etc. storing the software and/or firmware. Further still, the example platform 100 of FIG. 1 and the example cache manager 108 of FIG. 4 may include one or more elements, processes and/or devices in addition to, or instead of, those illustrated in FIGS. 1-4, and/or may include more than one of any or all of the illustrated elements, processes and devices.

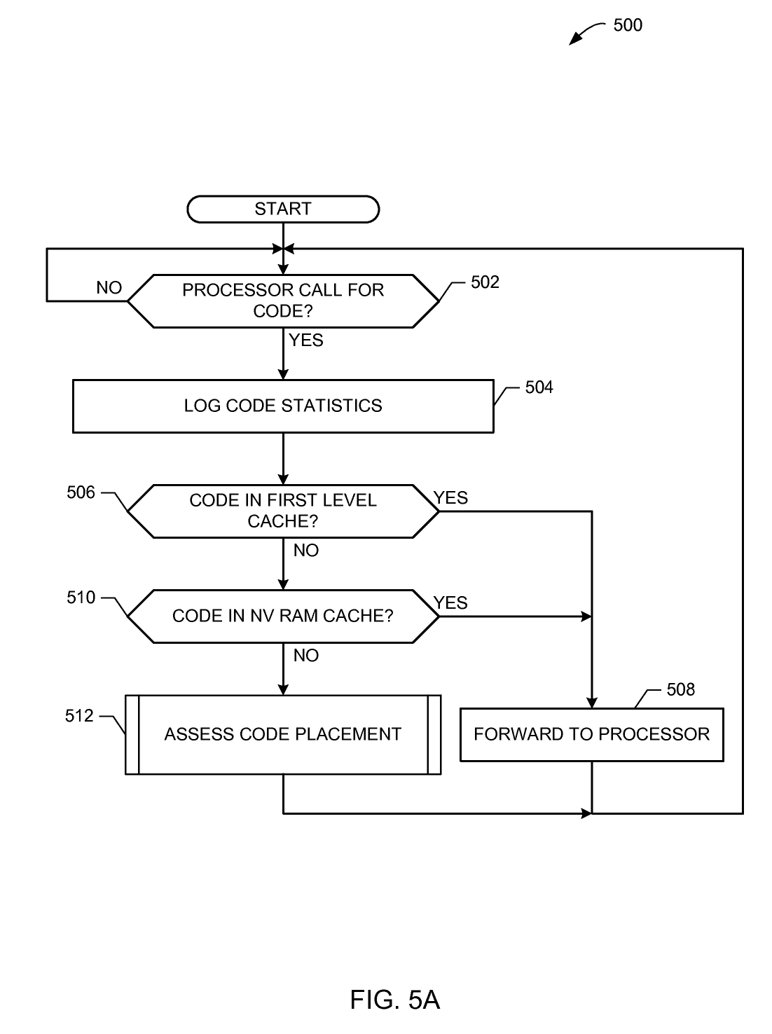

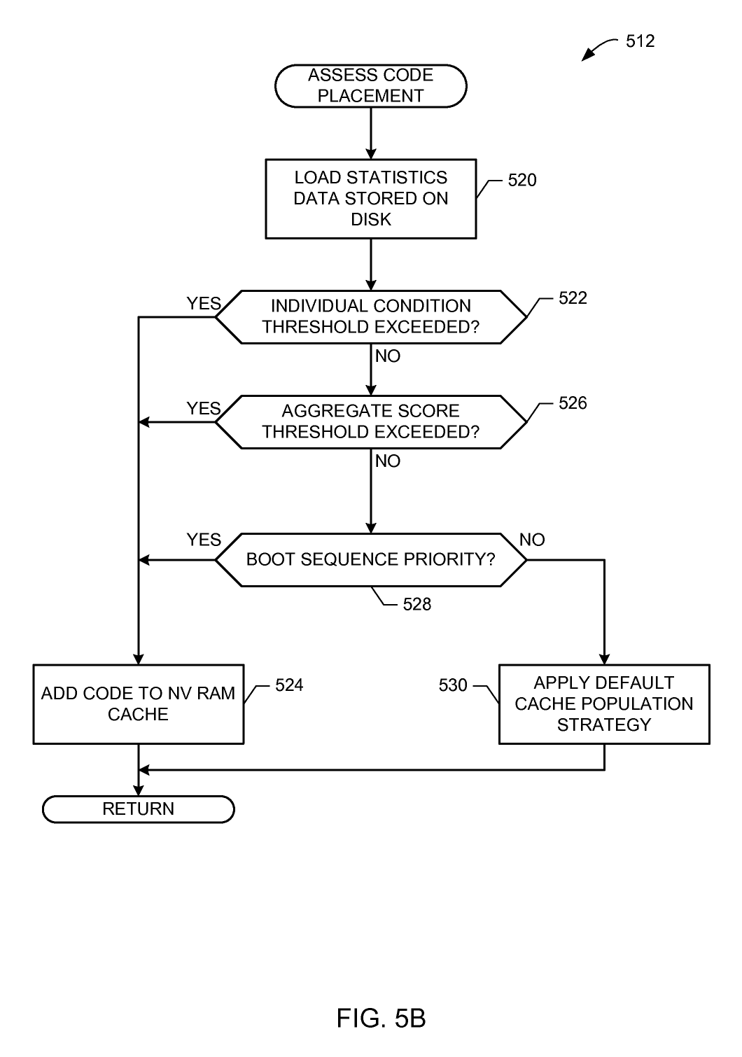

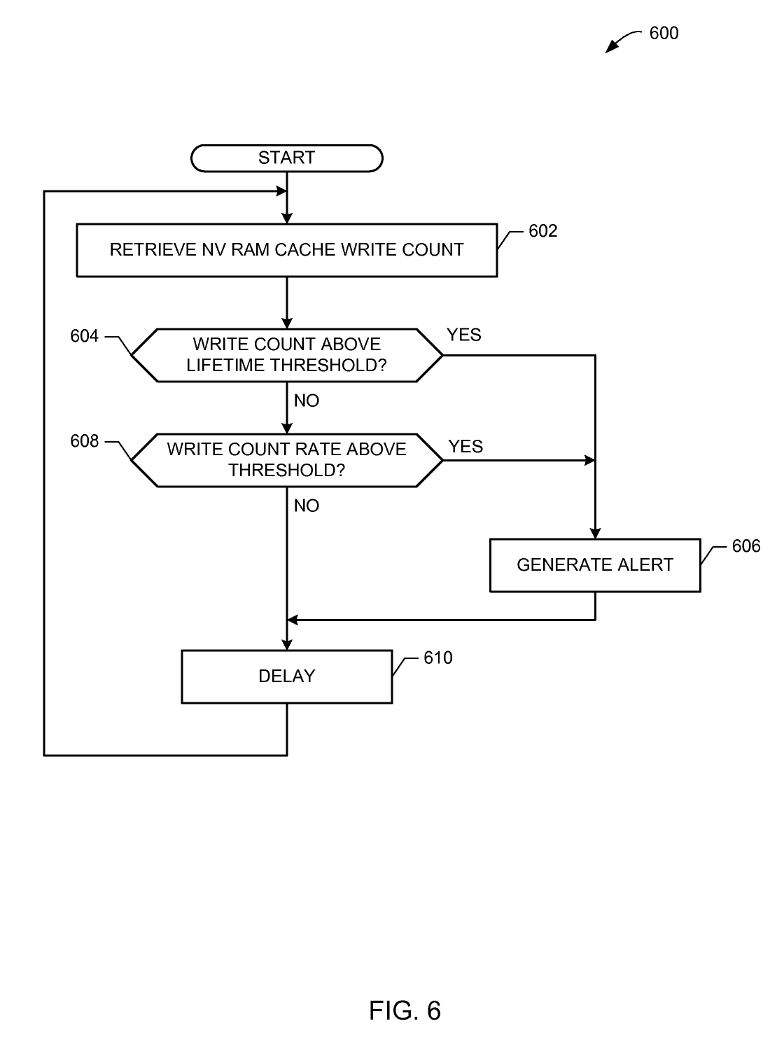

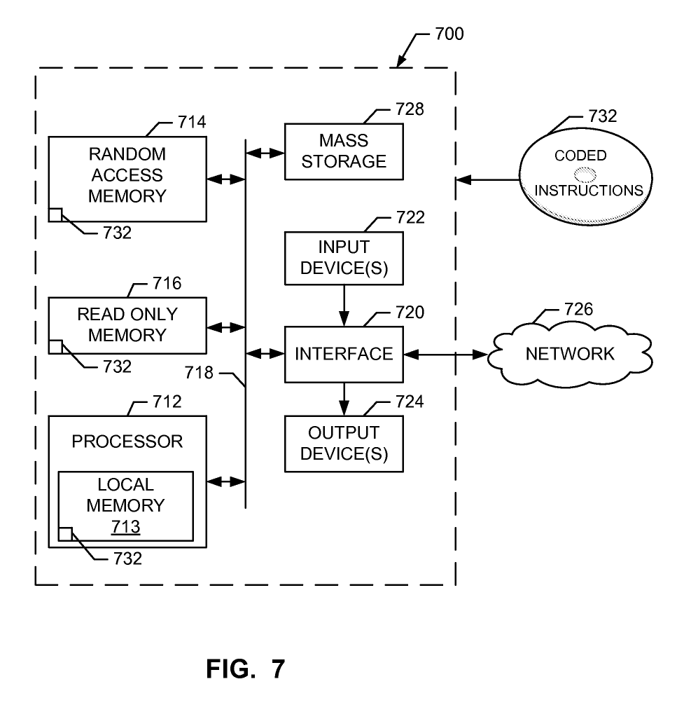

Flowcharts representative of example machine readable instructions for implementing the platform 100 of FIG. 1 and the example cache manager 108 of FIGS. 1-4 are shown in FIGS. 5A, 5B and 6. In this example, the machine readable instructions comprise a program for execution by a processor such as the processor 712 shown in the example computer 700 discussed below in connection with FIG. 7. The program may be embodied in software stored on a tangible computer readable storage medium such as a CD-ROM, a floppy disk, a hard drive, a digital versatile disk (DVD), a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowcharts illustrated in FIGS. 5A, 5B and 6, many other methods of implementing the example platform 100 and the example cache manager 108 to cache code in non-volatile memory may alternatively be used. For example, the order of execution of the blocks may be changed, and/or some of the blocks described may be changed, eliminated, or combined.

As mentioned above, the example processes of FIGS. 5A, 5B and 6 may be implemented using coded instructions (e.g., computer readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device and/or storage disc in which information is stored for any duration (e.g., for extended time periods, permanently, brief instances, for temporarily buffering, and/or for caching of the information). As used herein, the term tangible computer readable storage medium is expressly defined to include any type of computer readable storage device and/or storage disc and to exclude propagating signals. Additionally or alternatively, the example processes of FIGS. 5A, 5B and 6 may be implemented using coded instructions (e.g., computer readable instructions) stored on a non-transitory computer readable storage medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable storage device and/or storage disc and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

The program 500 of FIG. 5A begins at block 502 where the example processor call monitor 402 determines whether the example processor 102 invokes a call for code. If not, the example processor call monitor 402 waits for a processor call, but if a call occurs, the example code statistics engine 404 logs statistics associated with the code call (block 504). In some examples, one or more statistics may not be readily available until after one or more prior iteration(s) of processor call(s). As discussed above, statistics for each candidate portion of code are monitored and stored in an effort to characterize the example platform 100 and/or the example code portions that execute on the platform 100. Code statistics may include, but are not limited to a number of times the candidate code is requested and/or otherwise invoked by the processor 102, a number of processor cycles or seconds (e.g., milliSeconds) consumed by translating, compiling and/or optimizing the candidate code, a size of the code and/or a time to access the candidate code from cache memory (e.g., L1 cache 112 access time, NV RAM cache 114 access time, etc.).

In the event the example cache interface 406 determines that the candidate code is located in the first level cache 112 (block 506), then it is forwarded to the example processor 102 (block 508). If the candidate code is not in the first level cache 112 (block 506), then the example cache interface 406 determines if the candidate code is already in the NV RAM cache 114 (block 510). If so, then the candidate code is forwarded to the example processor 102 (block 508), otherwise the example cache manager 108 determines whether the candidate code should be placed in the NV RAM cache 114 for future accessibility (block 512).

The program 512 of FIG. 5B begins at block 520 where the example code statistics engine 404 accesses and/or otherwise loads data associated with the candidate code stored on disk, such as the example storage 106 of FIG. 1. In some examples, the statistics data is loaded from the example storage 106 and stored in RAM 104 so that latency access times are reduced. The example condition threshold engine 408 identifies statistics associated with the candidate code requested by the example processor 102 to determine whether one or more individual condition thresholds are exceeded (block 522). As described above, each condition may have a different threshold value that, when exceeded, invokes the example cache interface 406 to add the candidate code to NV RAM cache 114 (block 524). For example, if the candidate code is accessed at a relatively high frequency (e.g., when compared to other code requested by the example processor 102), then its corresponding access count value may be higher than the threshold associated with the example access frequency score 202 of FIG. 2. In such example circumstances, adding the candidate code to NV RAM cache 114 facilitates faster code execution by eliminating longer latency disk access times and/or re-compilation efforts.

If no individual condition threshold is exceeded by the candidate code (block 522), then the example condition threshold engine 408 determines whether an aggregate score threshold is exceeded (block 526). If so, then the example cache interface 406 adds the candidate code to NV RAM cache 114 (block 524). If the aggregate score threshold is not exceeded (block 526), then the example NV RAM priority profile manager 410 determines whether the candidate code is associated with startup task(s) (block 528), such as boot sequence code. In some examples, a designation that the candidate code is associated with a boot sequence causes the cache interface 406 to add the candidate code to the NV RAM cache 114 so that subsequent start-up activities operate faster by eliminating re-compilation, re-optimization and/or re-translation efforts. The example NV RAM priority profile manager 410 may store one or more profiles associated with each platform of interest to facilitate user controlled settings regarding the automatic addition of candidate code to the NV RAM cache 114 when such candidate code is associated with startup task(s). In the event that no individual condition threshold is exceeded (block 522) and no aggregate score threshold is exceeded (block 526), and the candidate code is not associated with startup task(s) (block 528), then the example cache manager 108 employs one or more default cache optimization techniques (block 530), such as least-recently used (LRU) techniques, default re-compilation and/or storage 106 access.

In some examples, the cache manager 108 determines whether the example NV RAM cache 114 is near or exceeding its useful life write cycle value. As discussed above, while NV RAM cache 114 exhibits favorable latency characteristics comparable to DRAM and is non-volatile to avoid relatively lengthy latency access times associated with disk storage 106, the NV RAM cache 114 has a limited number of cache cycles before it stops working. The program 600 of FIG. 6 begins at block 602 where the example code statistics engine 404 retrieves NV RAM write count values. The example NV RAM priority profile manager 410 determines whether the write count of the NV RAM cache 114 is above its lifetime threshold (block 604) and, if so, invokes the example alert module 412 to generate one or more alerts (block 606). The example alert module 412 may invoke any type of alert to inform a platform manager that the NV RAM cache 114 is at or nearing the end of its useful life, such as system generated messages and/or prompt messages displayed during power-on reset activities of the example platform 100.

In the event the NV RAM priority profile manager 410 determines that the NV RAM cache 114 is not at the lifetime threshold value (block 604), then the example NV RAM priority profile manager 410 determines whether a rate of write cycles is above a rate threshold (block 608). In some examples, platform 100 operation may change in a manner that accelerates a number of write operations per unit of time, which may shorten the useful life of the NV RAM cache 114 during a relatively shorter time period. Such changes in platform operation and/or rate of write cycles are communicated by the example alert module 412 (block 606) so that platform managers can take corrective action and/or plan for replacement platform components. The example program 600 of FIG. 6 may employ a delay (block 610) so that write count values can be updated on a periodic, aperiodic and/or manual basis.

FIG. 7 is a block diagram of an example processor platform 700 capable of executing the instructions of FIGS. 5A, 5B and 6 to implement the platform 100 of FIG. 1 and/or the cache manager 108 of FIGS. 1-4. The processor platform 700 can be, for example, a server, a personal computer, an Internet appliance, a mobile device, or any other type of computing device.

The system 700 of the instant example includes a processor 712. For example, the processor 712 can be implemented by one or more microprocessors or controllers from any desired family or manufacturer.

The processor 712 includes a local memory 713 (e.g., a cache, such as cache 112, 114) and is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The processor platform 700 also includes an interface circuit 720. The interface circuit 720 may be implemented by any type of interface standard, such as an Ethernet interface, a universal serial bus (USB), and/or a PCI express interface.

One or more input devices 722 are connected to the interface circuit 720. The input device(s) 722 permit a user to enter data and commands into the processor 712. The input device(s) can be implemented by, for example, a keyboard, a mouse, a touchscreen, a track-pad, a trackball, isopoint and/or a voice recognition system.

One or more output devices 724 are also connected to the interface circuit 720. The output devices 724 can be implemented, for example, by display devices (e.g., a liquid crystal display, a cathode ray tube display (CRT), a printer and/or speakers). The interface circuit 720, thus, typically includes a graphics driver card.

The interface circuit 720 also includes a communication device such as a modem or network interface card to facilitate exchange of data with external computers via a network 726 (e.g., an Ethernet connection, a digital subscriber line (DSL), a telephone line, coaxial cable, a cellular telephone system, etc.).

The processor platform 700 also includes one or more mass storage devices 728 for storing software and data. Examples of such mass storage devices 728 include floppy disk drives, hard drive disks, compact disk drives and digital versatile disk (DVD) drives.

The coded instructions 732 of FIGS. 5A, 5B and 6 may be stored in the mass storage device 728, in the volatile memory 714, in the non-volatile memory 716, and/or on a removable storage medium such as a CD or DVD.

Methods, apparatus, systems and articles of manufacture to cache code in non-volatile memory disclosed herein improve platform operation by reducing latency associated with processor fetch operations to disk storage. In particular, processor disk storage fetch operations are relatively frequent after a platform power reset because previously compiled, optimized and/or otherwise translated code that was stored in traditional cache devices is not retained when power is removed. Additionally, example methods, apparatus, systems and articles of manufacture to cache code in non-volatile memory disclosed herein judiciously manage attempts to write to non-volatile random access memory that may have a limited number of lifetime write cycles.

Methods, apparatus, systems and articles of manufacture are disclosed to cache code in non-volatile memory. Some disclosed example methods include identifying an instance of a code request for first code, identifying whether the first code is stored on non-volatile (NV) random access memory (RAM) cache, and when the first code is absent from the NV RAM cache, adding the first code to the NV RAM cache when a first condition associated with the first code is met and preventing storage of the first code to the NV RAM cache when the first condition is not met. Other disclosed methods include determining whether an aggregate threshold corresponding to the first condition and a second condition is met when the first condition is not met, in which the code request is initiated by a processor. In other disclosed methods, the code request is initiated by at least one of a compiler or a binary translator. In still other disclosed methods, the NV RAM cache permits byte level access, and in some disclosed methods the first condition comprises an access frequency count exceeds a threshold, in which setting the threshold for the access frequency count is based on an access frequency count value of second code, and/or setting the threshold for the access frequency count is based on an access frequency count value associated with a plurality of other code. Some example methods include the first condition having at least one of an access frequency count, a translation time, a code size, or a cache access latency. Other example methods include compiling the first code with a binary translator before adding the first code to the NV RAM cache, and still other example methods include tracking a number of processor requests for the first code, in which the first code is added to the NV RAM cache based on the number of requests for the first code. Still other example methods include tracking a number of write operations to the NV RAM cache, in which generating an alert when the number of write operations to the NV RAM cache exceeds a threshold write value associated with a lifetime maximum number of writes. Example disclosed methods also include overriding a storage attempt to the NV RAM cache when the first code is absent from a first level cache, in which the storage attempt to the NV RAM cache is associated with a least recently used storage policy.

Example apparatus to cache code in non-volatile memory include a first level cache to store compiled code, a second level non-volatile (NV) random access memory (RAM) cache to store the compiled code, and a cache interface to permit storage of the compiled code in the NV RAM if the compiled code is accessed at a greater than a threshold frequency, and to block storage of the compiled code on the NV RAM if the threshold frequency is not met. Some disclosed apparatus include the first level cache having dynamic random access memory. Other example disclosed apparatus include a profile manager to compare an expected lifetime write count value associated with the NV RAM cache with a current number of write count instances of the NV RAM cache. Still other disclosed apparatus include a condition threshold engine to set a threshold associated with a second condition to reduce a frequency of write count instances to the NV RAM cache.

Some disclosed example machine readable storage mediums comprising instructions that, when executed, cause a machine to identify an instance of a code request first code, identify whether the first code is stored on non-volatile (NV) random access memory (RAM) cache, and when the first code is absent from the NV RAM cache, add the first code to the NV RAM cache when a first condition associated with the first code is met and preventing storage of the first code to the NV RAM cache when the first condition is not met. Some example machine readable storage mediums include determining whether an aggregate threshold corresponding to the first condition and a second condition is met when the first condition is not met, while others include permitting byte level access via the NV RAM cache. Other disclosed machine readable storage mediums include identifying when the first condition exceeds a threshold count access frequency, in which setting the threshold for the access frequency count is based on an access frequency count value of second code. Still other disclosed example machine readable storage mediums include setting the threshold for the access frequency count based on an access frequency count value associated with a plurality of other code, while others include tracking a number of processor requests for the first code. Other disclosed machine readable storage mediums include adding the first code to the NV RAM cache based on the number of requests for the first code, and others include tracking a number of write operations to the NV RAM cache, in which the machine generates an alert when the number of write operations to the NV RAM cache exceeds a threshold write value associated with a lifetime maximum number of writes. Some disclosed machine readable storage mediums include overriding a storage attempt to the NV RAM cache when the first code is absent from a first level cache.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method to cache code, comprising:
identifying an instance of a code request for first code;
identifying whether the first code is stored on non-volatile (NV) random access memory (RAM) cache; and
when the first code is absent from the NV RAM cache, adding the first code to the NV RAM cache when a first condition associated with the first code is met and preventing storage of the first code to the NV RAM cache when the first condition is not met.

2. A method as defined in claim 1, further comprising determining whether an aggregate threshold corresponding to the first condition and a second condition is met when the first condition is not met.

3. A method as defined in claim 1, wherein the code request is initiated by a processor.

4. A method as defined in claim 1, wherein the code request is initiated by at least one of a compiler or a binary translator.

5. A method as defined in claim 1, wherein the NV RAM cache permits byte level access.

6. A method as defined in claim 1, wherein the first condition comprises an access frequency count exceeds a threshold.

7. A method as defined in claim 6, further comprising setting the threshold for the access frequency count based on an access frequency count value of second code.

8. A method as defined in claim 6, further comprising setting the threshold for the access frequency count based on an access frequency count value associated with a plurality of other code.

9. A method as defined in claim 1, wherein the first condition comprises at least one of an access frequency count, a translation time, a code size, or a cache access latency.

10. A method as defined in claim 1, further comprising compiling the first code with a binary translator before adding the first code to the NV RAM cache.

11. A method as defined in claim 1, further comprising tracking a number of processor requests for the first code.

12. A method as defined in claim 11, further comprising adding the first code to the NV RAM cache based on the number of requests for the first code.

13. A method as defined in claim 1, further comprising tracking a number of write operations to the NV RAM cache.

14. A method as defined in claim 13, further comprising generating an alert when the number of write operations to the NV RAM cache exceeds a threshold write value associated with a lifetime maximum number of writes.

15. A method as defined in claim 1, further comprising overriding a storage attempt to the NV RAM cache when the first code is absent from a first level cache.

16. A method as defined in claim 15, wherein the storage attempt to the NV RAM cache is associated with a least recently used storage policy.

17. An apparatus to store dynamically compiled code, comprising:
a first level cache to store the compiled code;
a second level non-volatile (NV) random access memory (RAM) cache to store the compiled code; and
a cache interface to permit storage of the compiled code in the NV RAM if the compiled code is accessed at a greater than a threshold frequency, and to block storage of the compiled code on the NV RAM if the threshold frequency is not met.

18. An apparatus as defined in claim 17, wherein the first level cache comprises dynamic random access memory.

19. An apparatus as defined in claim 17, further comprising a profile manager to compare an expected lifetime write count value associated with the NV RAM cache with a current number of write count instances of the NV RAM cache.

20. An apparatus as defined in claim 19, further comprising a condition threshold engine to set a threshold associated with a second condition to reduce a frequency of write count instances to the NV RAM cache.

21. A tangible machine readable storage medium comprising instructions that, when executed, cause a machine to, at least:
identify an instance of a code request for first code;
identify whether the first code is stored on non-volatile (NV) random access memory (RAM) cache; and
when the first code is absent from the NV RAM cache, add the first code to the NV RAM cache when a first condition associated with the first code is met and preventing storage of the first code to the NV RAM cache when the first condition is not met.

22. A machine readable storage medium as defined in claim 21, wherein the instructions, when executed, cause a machine to determine whether an aggregate threshold corresponding to the first condition and a second condition is met when the first condition is not met.

23. A machine readable storage medium as defined in claim 21, wherein the instructions, when executed, cause a machine to permit byte level access via the NV RAM cache.

24. A machine readable storage medium as defined in claim 21, wherein the instructions, when executed, cause a machine to identify when the first condition exceeds a threshold count access frequency.

25. A machine readable storage medium as defined in claim 24, wherein the instructions, when executed, cause a machine to set the threshold for the access frequency count based on an access frequency count value of second code.

26. A machine readable storage medium as defined in claim 24, wherein the instructions, when executed, cause a machine to set the threshold for the access frequency count based on an access frequency count value associated with a plurality of other code.

27. A machine readable storage medium as defined in claim 21, wherein the instructions, when executed, cause a machine to track a number of processor requests for the first code.

28. A machine readable storage medium as defined in claim 27, wherein the instructions, when executed, cause a machine to add the first code to the NV RAM cache based on the number of requests for the first code.

29. A machine readable storage medium as defined in claim 21, wherein the instructions, when executed, cause a machine to track a number of write operations to the NV RAM cache.

30. A machine readable storage medium as defined in claim 29, wherein the instructions, when executed, cause a machine to generate an alert when the number of write operations to the NV RAM cache exceeds a threshold write value associated with a lifetime maximum number of writes.

31. A machine readable storage medium as defined in claim 21, wherein the instructions, when executed, cause a machine to override a storage attempt to the NV RAM cache when the first code is absent from a first level cache.
